(19) United States
(12) Patent Application Publication
(10) Pub. No.: US 2016/0092119 A1
(43) Pub. Date: Mar. 31, 2016

(54) DATA MIGRATION BETWEEN DIFFERENT TYPES OF STORAGE SYSTEMS

(71) Applicant: International Business Machines Corporation, Armonk, NY (US)

(72) Inventors: Henry E. Butterworth, Shanghai (CN); Qi Hua Gao, Shanghai (CN); Long Wen Lan, Shanghai (CN)

(21) Appl. No.: 14/862,189

(22) Filed: Sep. 23, 2015

(30) Foreign Application Priority Data
Sep. 29, 2014 (CN) 201410514722.9

(51) Int. Cl. G06F 3/06; G06F 17/30

(52) U.S. Cl. CPC G06F 3/0613; G06F 3/0647; G06F 3/0685; G06F 17/30079; G06F 17/30233

(57) ABSTRACT

Data migration from a source data storage system to a target data storage system, where the source and target data storage systems are of two different types, using a virtual file system to store the data at the target data storage system, with the target data storage system being configured to store data in the manner of the source data storage system. In some embodiments, more convenient and efficient data migration can be provided without changing the architecture of an existing data storage system as far as possible.

### BACKGROUND

Various embodiments of the present invention relate to the management of data storage, and more specifically, to a method and apparatus for data migration.

With the development of data storage technology, there have been developed various types of data storage systems. In order to maintain the normal operation of a data storage system, usually a provider of the data storage system will intermittently update hardware and software configurations in the data storage system, for example, expand the storage capacity of the data storage system or adopt a novel data storage system as new technology is proposed. Examples of types of data storage systems may comprise, for example, Storage Area Network (SAN) and Network Attached Storage (NAS).

The SAN is implemented through Fiber Channel based Small Computer System Interface (SCSI) technology. The Fiber Channel uses high-frequency serial bit transfer and thus can achieve a very high data transmission rate, and the transmission distance now reaches such an order of magnitude as 10 Km (kilometers). Therefore, the SAN is quite suitable to provide data storage services for clients within specific data scope (e.g., large enterprises). However, since the SAN relies on the Fiber Channel, high manpower and material costs will be caused when deploying and expanding the SAN initially. As a result, providers of storage systems turn to seek other alternative data storage technology.

So far there has been developed NAS, which is a burgeoning data storage technology. According to this technology, storage devices attached to a network may provide centralized data storage services to various clients that are connected to the network. Specifically, a NAS system can provide high-performance file sharing and storage services, and clients can access files with the IP network. Network Attached Storage is put to wide application in large enterprises, especially multinationals.

At the beginning of building a Network Attached Storage system, typically an enterprise only deploys a couple of servers for storing data. As the enterprise scale expands and branches increase, the enterprise begins to expand the original server capacity and deploys more servers at a plurality of physical locations (for example, cities in different countries/regions).

Data storage systems usually comprise massive data. When a storage system provider wants to migrate data from one storage system to another, data migration typically takes several days or even longer.

### SUMMARY

According to an aspect of the present invention, a method for data migration includes the following operations (not necessarily in the following order): (i) receiving a migration request for data migration from a source storage system to a target storage system, with the source storage system and the target storage system being of different types of storage systems; (ii) building a virtual file system for reading data blocks in the source storage system; and (iii) migrating a plurality of data blocks in the source storage system to the target storage system via the virtual file system.

According to a further aspect of the present invention, an apparatus for data migration includes: (i) a receiving module configured to receive a migration request for data migration from a source storage system to a target storage system, with the source storage system and the target storage system being of different types of storage systems; (ii) a building module configured to build a virtual file system for reading data blocks in the source storage system; and (iii) a migrating module configured to migrate a plurality of data blocks in the source storage system to the target storage system via the virtual file system.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 schematically depicts a block diagram of an exemplary computer system/server which is applicable to implement the embodiments of the present invention;

FIG. 2 schematically depicts a cloud computing environment according to an embodiment of the present invention;

FIG. 3 schematically depicts abstraction model layers provided by cloud computing environment 50 (FIG. 2);

FIG. 4 schematically depicts a block diagram of data migration according to one technical solution;

FIG. 5 schematically depicts a block diagram of a technical solution for data migration according to one embodiment of the present invention;

FIG. 6 schematically depicts a flowchart of a method for data migration according to one embodiment of the present invention;

FIG. 7 schematically depicts a detailed block diagram of a technical solution for data migration according to one embodiment of the present invention;

FIG. 8 schematically depicts a block diagram of a technical solution for accessing data in a storage system during data migration according to one embodiment of the present invention; and

FIG. 9 schematically depicts a block diagram of an apparatus for data migration according to one embodiment of the present invention.

### DETAILED DESCRIPTION

It is desired to develop a technical solution capable of migrating data conveniently and efficiently. It is desired that the technical solution can reduce the service down time for a data storage system as far as possible, and it is desired that clients still can access the data storage system during data migration.

In one embodiment of the present invention, there is provided a method for data migration, the method comprising: receiving a migration request for data migration from a source storage system to a target storage system; building a virtual file system for reading data blocks in the source storage system; and migrating data blocks in the source storage system to the target storage system via the virtual file system, wherein the source storage system and the target storage system are storage systems of different types.

In one embodiment of the present invention, there is provided an apparatus for data migration, the method comprising: a receiving module configured to receive a migration request for data migration from a source storage system to a target storage system; a building module configured to build a virtual file system for reading data blocks in the source storage system; and a migrating module configured to migrate data blocks in the source storage system to the target storage system via the virtual file system, wherein the source storage system and the target storage system are storage systems of different types.

In some embodiments of the present invention, more convenient and efficient data migration can be provided without changing the architecture of an existing data storage system as far as possible. Furthermore, in some embodiments of the present invention, a client accessing a data storage system can still access the data storage system during data migration, instead of, as in the prior art, waiting for hours or even longer and accessing the data storage system until the data migration is completed.

Some embodiments will be described in more detail with reference to the accompanying drawings, in which these embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with a given service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

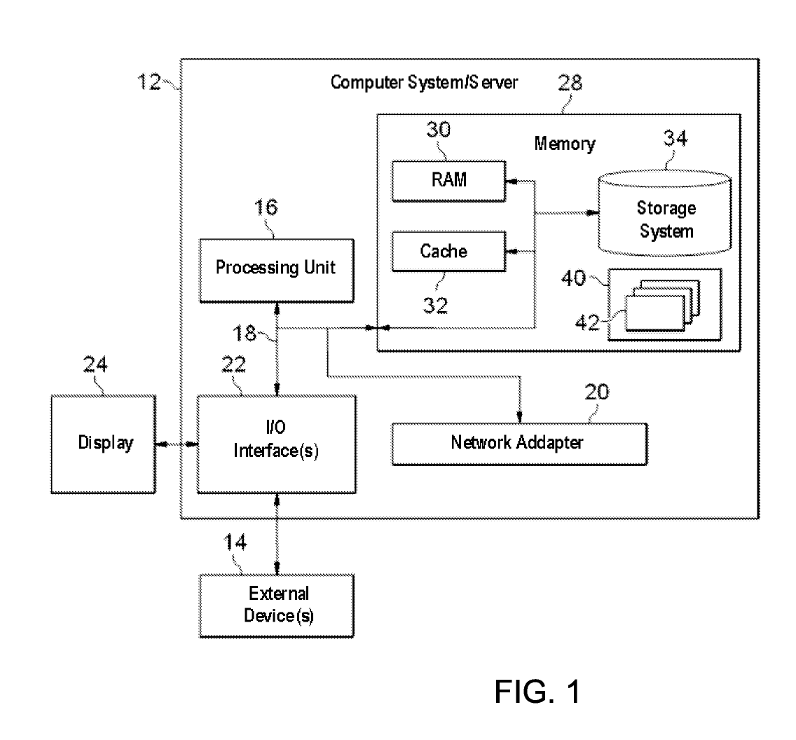

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

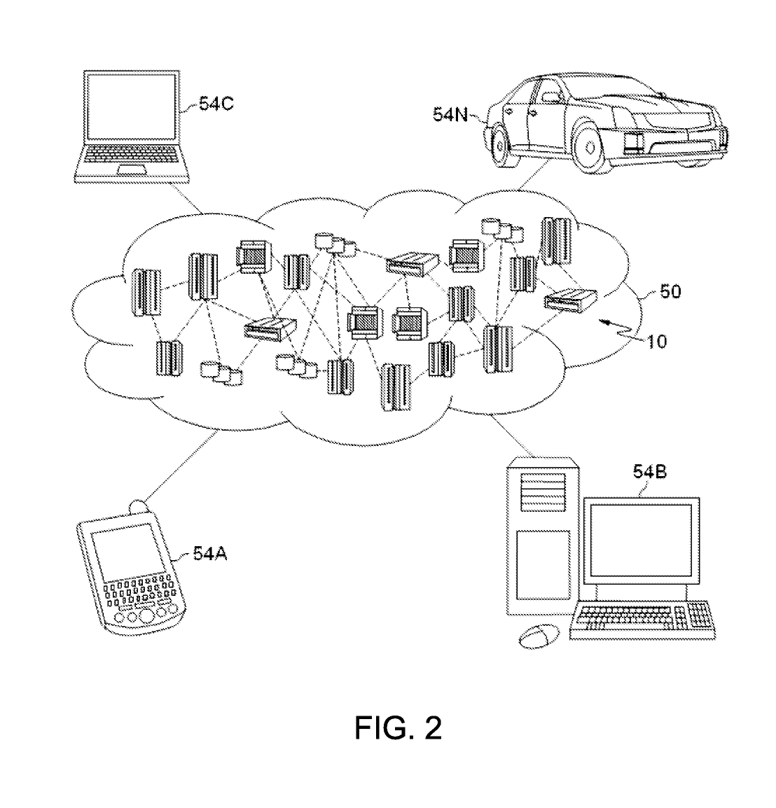

Referring now to FIG. 2, illustrative cloud computing environment 50 is depicted. As shown, cloud computing environment 50 comprises one or more cloud computing nodes 10 with which local computing devices used by cloud consumers may communicate. The local computing devices may be, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

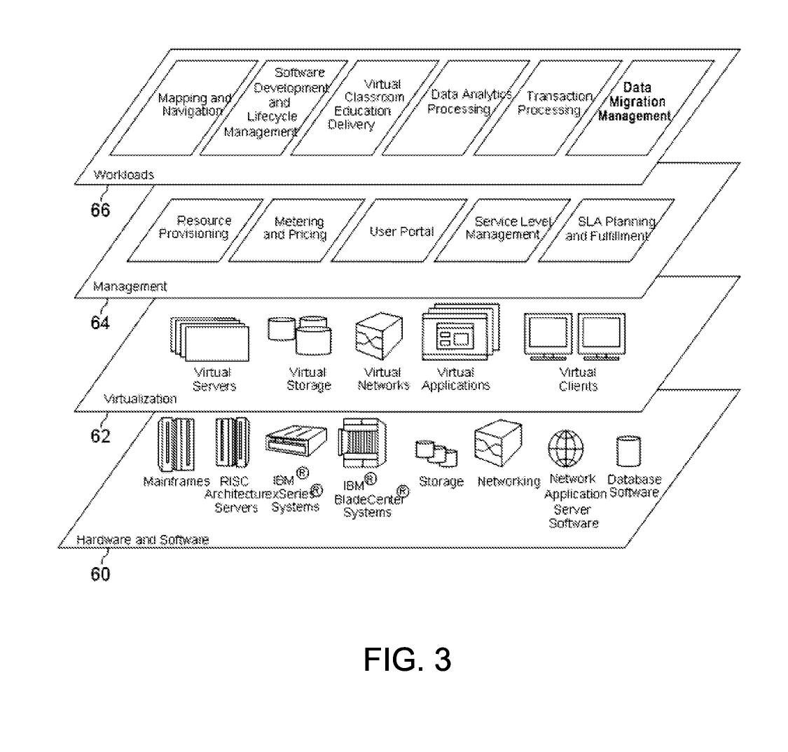

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes (e.g. IBM® zSeries® systems); RISC (Reduced Instruction Set Computer) architecture based servers (e.g., IBM pSeries® systems); IBM xSeries® systems; IBM BladeCenter® systems; storage devices; networks and networking components. Examples of software components include network application server software (e.g., IBM WebSphere® application server software); and database software (e.g., IBM DB2® database software). (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data migration management.

In one embodiment of the present invention, the technical solution for data migration according to various embodiments of the present invention may be implemented at workloads layer 66, so as to conveniently provide data migration tools to the storage system provider in a cloud computing environment. An application environment of the present invention has been illustrated above. Those skilled in the art should understand that the embodiments of the present invention may further be implemented in any other type of application environment that is known currently or to be developed later.

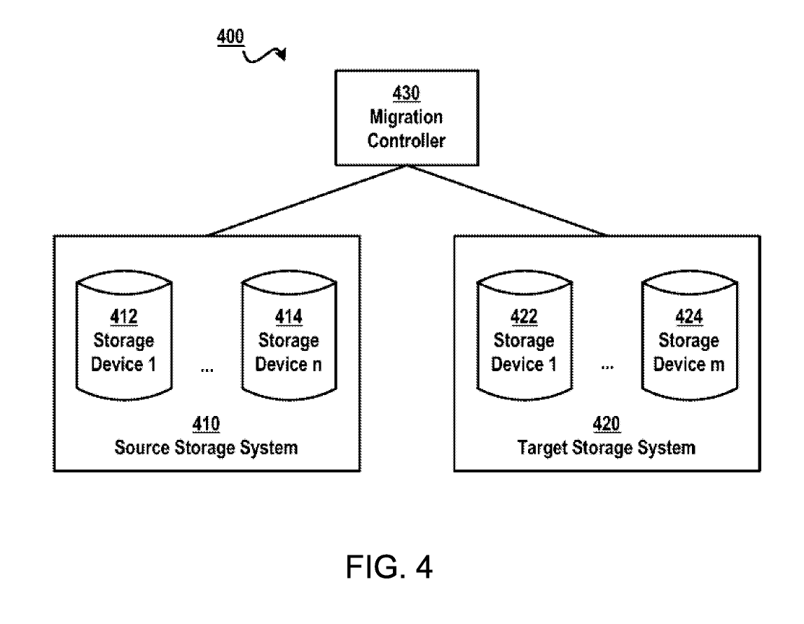

FIG. 4 schematically shows a block diagram 400 of data migration according to one technical solution. As shown in FIG. 4, a source storage system 410 includes: a plurality of source side storage devices, including storage device 1 412, a storage device n 414; a target storage system 420 including a plurality of storage devices, which include storage device 1 422, storage device m 424. Data migration from source storage system 410 to target storage system 420 is implemented by means of a third-party migration controller 430. Being independent of source storage system 410 and target storage system 420, migration controller 430 is connected via a data network to: (i) source storage system 410; and (ii) target storage system 420. When performing data migration, data needs to be transmitted via the data network. When data migration involves a large amount of data, it takes hours or even days, which is potentially costly in terms of time and disruption for both the managers and the users of the storage system.

During normal operation, source storage system 410 has to support a large quantity of access from clients; however, in order to ensure the data consistency during data migration, data access services of source storage system 410 have to stop. After completing data migration from source storage system 410 to target storage system 420, complex manual configuration is further needed before the client is enabled to access data stored in target storage system 420 according to new specifications (e.g., file formats supported by the target storage system).

Some embodiments of the present invention may perform data migration more efficiently. In view of the above drawbacks in the prior art, the present invention provides a technical solution for data migration. Specifically, there is proposed a method for data migration, comprising: receiving a migration request for data migration from a source storage system to a target storage system; building a virtual file system for reading data blocks in the source storage system; and migrating data blocks in the source storage system to the target storage system via the virtual file system, wherein the source storage system and the target storage system are storage systems of different types.

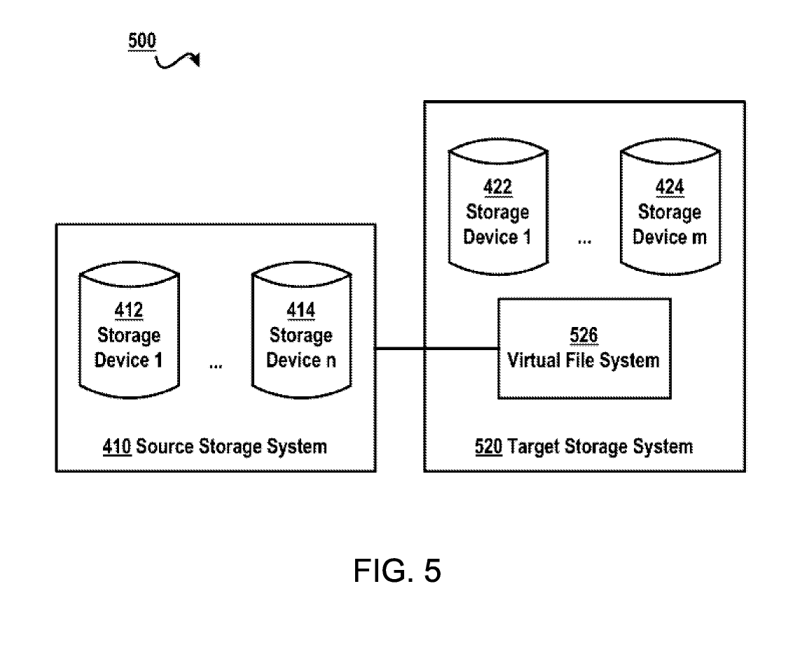

FIG. 5 schematically shows a block diagram 500 of a technical solution for data migration according to one embodiment of the present invention. As shown in FIG. 5, source storage system 410 may be similar to a source technical solution in the prior art. Unlike the data migration technology shown above in FIG. 4, according to the embodiment of the present invention represented by diagram 500, a virtual file system for reading data blocks in the source storage system may be built. Specifically, in this embodiment, virtual file system 526 is built in a target storage system 520 to directly read data blocks from source storage system 410, rather than data being delivered via a third-party migration controller. Thereby, time overheads for data migration can be reduced significantly. In the context of the present invention, the data block may represent one data file or may represent a folder comprising multiple data files. Therefore, the technical solution of the present invention may be implemented with respect to each data block in the context of the present invention.

Generally, the data transmission rate inside the storage system is much higher than the rate of transmission that is implemented via a data network outside the storage system. By means of the technical solution of the present invention, when directly reading data blocks in source storage system 410 by virtual file system 526, high-efficient data transmission paths within various storage systems may be used as far as possible, thereby eliminating the need to forward data via a third-party device.

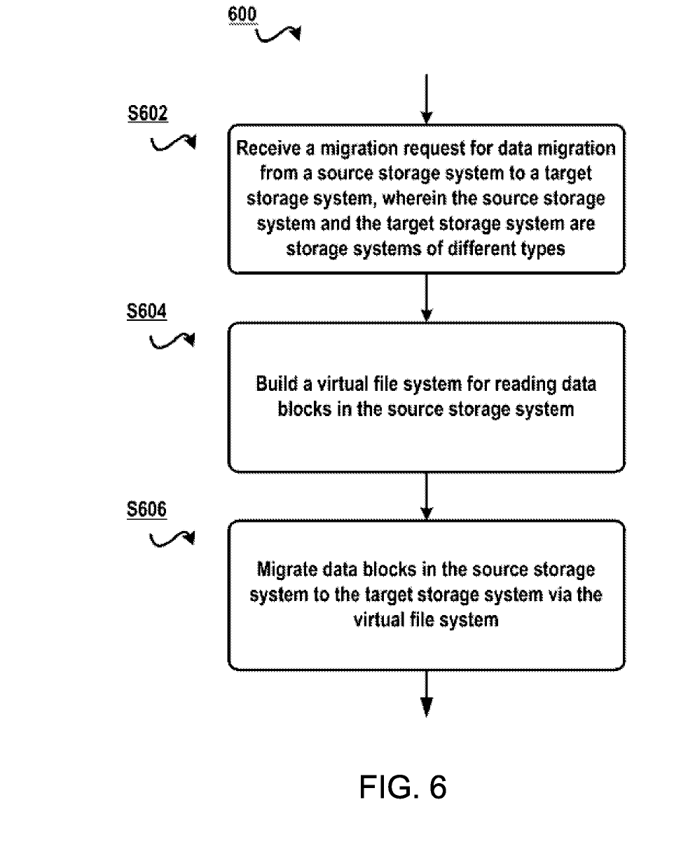

FIG. 6 schematically shows a flowchart 600 of a method for data migration according to one embodiment of the present invention. As shown in this figure, in step S602, a migration request for data migration from a source storage system to a target storage system is received, wherein the source storage system and the target storage system are storage systems of different types. When the source storage system and the target storage system are of different types, file system formats supported by them also differ. Therefore, the compatibility between file system formats needs to be considered when performing data migration.

In step S604, a virtual file system for reading data blocks in the source storage system is built. The purpose of building the virtual file system is that the virtual file system may directly read data blocks from the source storage system. For example, the virtual file system may be built on the basis of an interface for data access as provided by the source storage system to the outside. Specifically, during operation of the source storage system, a data access application on a client of the source storage system may access data blocks stored in the source storage system. Those skilled in the art may design the virtual file system in a manner similar to implementing a data access application.

In step S606, data blocks in the source storage system are migrated to the target storage system via the virtual file system. Where the virtual file system has been achieved, data may directly be read from the source storage system via the virtual file system, and read data blocks are stored to the target storage system. In some embodiments, at step S606, the data blocks are also moved: (i) from target storage space configured as a virtual file system (see, for example, FIG. 5 at virtual file system 526); and (ii) to target storage space configured according to the configuration primarily associated with the target storage space (see FIG. 5 at storage device 1 422 and storage device m 424).

In one embodiment of the present invention, the building the virtual file system for reading data blocks in the source storage system comprises: obtaining a source file system description of the source storage system and a target file system description supported by the target storage system respectively; and building the virtual file system on the basis of the source file system description and the target file system description.

Specifically, functions of the virtual file system may be achieved on the basis of file system descriptions of the source storage system and the target storage system. In this embodiment, the source storage system may be connected to the target storage system as external storage of the target storage system, for example, the source storage system may be accessed in an “image mode.” In the image mode, data blocks stored in the source storage system may be presented in an original format of the source file system of the source storage system.

In this embodiment, various attribute information in the source file system description may be read. For example, the attribute information may describe basic information in a file/folder in the source storage system, for example, may include ID, name, created time, last modified time, size, version number and other information of the file/folder.

Using the above information, relevant attributes of the file/folder may be obtained, a location of the file/folder in the source storage system found, and further the virtual file system built. In the virtual file system, each file/folder has it unique virtual path. The virtual file system achieves a mapping relationship from actual storage locations of files/folders to virtual paths, so that the target storage system may read data blocks in the source storage system.

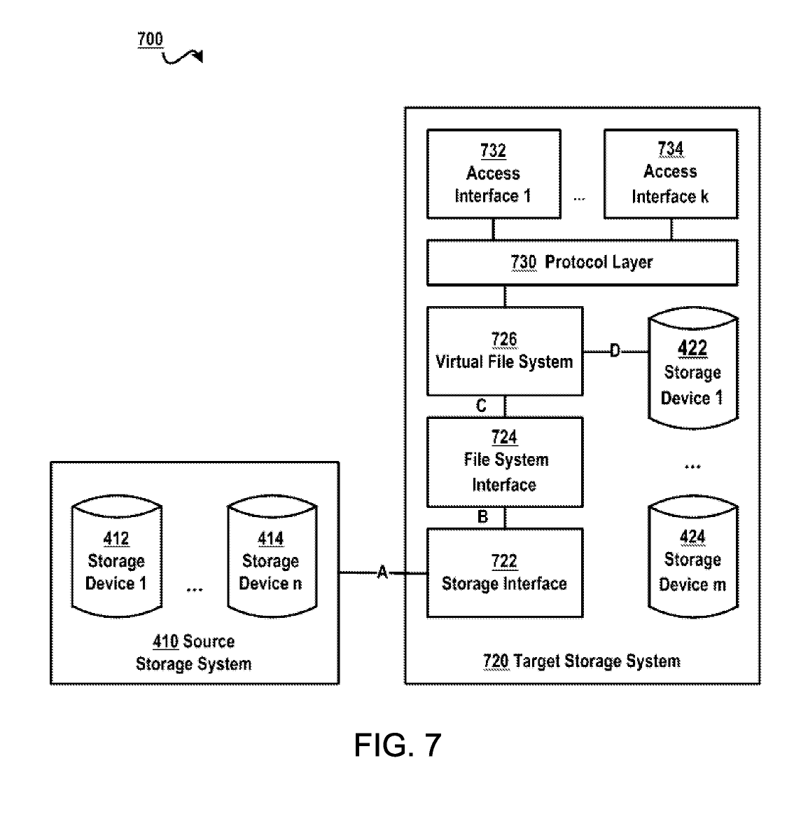

In one embodiment of the present invention, the virtual file system is implemented in the target storage system. Specifically, FIG. 7 schematically shows a detailed block diagram 700 of a technical solution for data migration according to one embodiment of the present invention. As shown in this figure, a target storage system 720 includes: storage device 1 422, . . . , storage device m 424, protocol layer 730, as well as access interface 1 732, . . . , access interface k 734.

Unlike existing technical solutions implemented using a migration controller, virtual file system 726 is built into target storage system 720, which virtual file system 726 may retrieve data blocks that are stored in source storage system 410, from file system interface 724 according to a file format supported by source storage system 410. In this embodiment, storage interface 722 refers to an interface that connects source storage system 410 to target storage system 720 as external storage, for example, may read data blocks in source storage system 410 using the above-described image mode.

Alternatively, virtual file system 726 may further be deployed at other location. For example, in the cloud computing environment, virtual file system 726 may be provided by a provider that specially provides data interface services. At this point, data blocks in the source storage system may be migrated via virtual file system 726 to the target storage system.

In one embodiment of the present invention, a connection may be built between target storage system 720 and source storage system 410 (as shown by a mark A) so that virtual file system 726 in target storage system 720 can access data blocks in source storage system 410. While performing data migration, virtual file system 726 can read to-be-migrated data blocks in source storage system 410 via a path as shown by marks A-B-C, and store read data blocks to storage device 1 422, . . . , storage device m 424 via a connection shown by a mark D, thereby achieving data migration.

With the technical solution of the present invention, source storage system 410 may become external storage of target storage system 720, and target storage system 720 provides data storage services to the client. Therefore, at this point it may be considered the ongoing data migration operation is a data operation inside the target storage system.

When performing a conventional technical solution for data migration, source storage system 410 must stop data storage services for a long time in order to ensure the data consistency. According to the technical solution of the present invention, however, target storage system 720 provides data storage services to the outside, so the client still can access data during data migration.

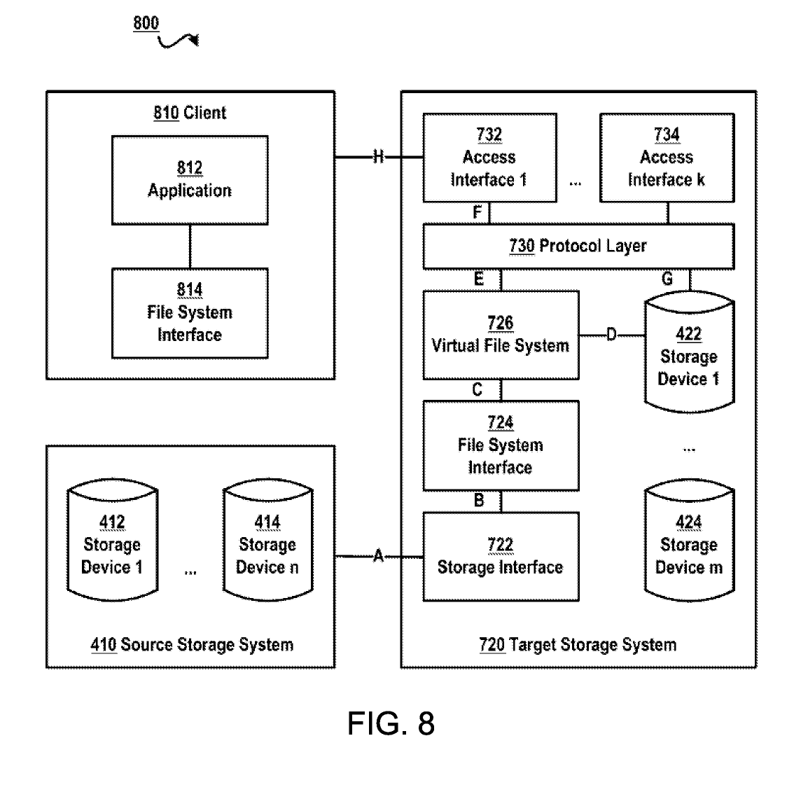

Specifically, FIG. 8 schematically shows a block diagram 800 of a technical solution for accessing data in a storage system during data migration according to one embodiment of the present invention. Source storage system 410 and target storage system 720 in FIG. 8 are the same as those in FIG. 7, and the difference is that a client 810 is further shown in FIG. 8. Client 810 may comprise an application 812 and a file system interface 814, which file system interface 814 is an interface that supports data access from source storage system 410. During normal operation of source storage system 410, client 810 is directly connected to source storage system 410, and application 812 accesses data blocks in source storage system 410 via file system interface 814.

In one embodiment of the present invention, there is further comprised: in response to detecting an access request of a client to the source storage system, guiding the access request to the target storage system; and providing by the target storage system a data block requested by the access request.

In this embodiment, in response to detecting an access request of the client to the source storage system, a connection may be built between client 810 and target storage system 720 (as shown by a mark H), and target storage system 720 provides an accessed data block to client 810. In this embodiment, it may be considered that source storage system 410 is external storage of target storage system 720.

In the context of the present invention, the progress of data migration may further be recorded so as to learn which data blocks in source storage system 410 have been migrated, which ones are being migrated and which ones have not been migrated. Specifically, in one embodiment of the present invention, the migrating data blocks in the source storage system to the target storage system via the virtual file system comprises: with respect to data blocks in the source storage system, on the basis of the progress of copying the data blocks from the source storage system to the target storage system, setting metadata that describes migration status of the data blocks, the metadata comprising at least one of “unmigrated,” “under migration” and “migrated.”

Those skilled in the art may design various data formats to represent the metadata, for example, may set a status indicator with respect to each data block in the source storage system and store the metadata as shown in Table 1 below. Table 1 Status of Data Migration:

| No. | Data Block ID | Metadata |
|---|---|---|
| 1 | data block 1 | unmigrated |
| 2 | data block 2 | under migration |
| 3 | data block 3 | migrated |
| . . . | . . . | . . . |

Table 1 merely illustrates one specific example of status of data migration, and those skilled in the art may further record status of data migration in other fashion. For example, three lists may be set for saving IDs of data blocks that have not been migrated, are under migration and have been migrated respectively. Status information of data migration may serve as one part of virtual file system 726 or be stored in a storage device that is accessible to virtual file system 726.

In one embodiment of the present invention, the providing by the target storage system the data block requested by the access request comprises: determining migration status of the requested data block on the basis of the metadata; and providing the requested data block on the basis of the migration status of the requested data block. Specifically, it may be determined, on the basis of the migration status as recorded in Table 1 above, from which storage device the requested data block is to be provided. Note the access request from the client may involve one or more data blocks, so processing may be performed with respect to each of the requested one or more data blocks.

In one embodiment of the present invention, the providing the requested data block on the basis of the migration status of the requested data block comprises: in response to the migration status being “unmigrated,” providing the requested data block from data storage of the source storage system.

“Unmigrated” represents that the requested data block has not yet been migrated from source storage system 410 to target storage system 720. As source storage system 410 is external storage of target storage system 720 at this point, the requested data block may be accessed from source storage system 410 via target storage system 720 and provided to client 810.

For the concrete operation procedure, reference may be made to FIG. 8. Like the method shown in FIG. 7, virtual file system 726 may access data blocks in source storage system 410 via the path shown by marks A-B-C; subsequently, the requested data block may be provided to client 810 via a path shown by marks E-F-H. In this embodiment, protocol layer 730 may support a variety of file system formats, so that data storage services may be provided via access interface 1 732, . . . , access interface k 734 to clients outside target storage system 720.

In one embodiment of the present invention, the providing the requested data block on the basis of the migration status of the requested data block comprises: in response to the migration status being “migrated,” providing the requested data block from data storage of the target storage system.

With reference to FIG. 7 above, description has been presented to that virtual file system 726 may migrate data from source storage system 410 to target storage system 720 via the path A-B-C-D, and subsequently protocol layer 730 may access data blocks in storage device 1 422, . . . , storage device m 424 via the connection G, so when it is found that the data block requested by client 810 has been migrated to target storage system 720, the requested data block may be provided to client 810 via any of access interface 1 732, . . . , access interface k 734.

In one embodiment of the present invention, the providing the requested data block on the basis of the migration status of the requested data block comprises: in response to the migration status being “under migration,” determining size of an unmigrated part of the requested data block; and in response to the size being larger than a predefined threshold, quitting the data migration and providing the requested data block from data storage of the source storage system; otherwise, delaying the access request until the data migration is completed, and providing the requested data block from data storage of the target storage system.

In one embodiment of the present invention, when it is found that the data block requested by the client is under migration, judgment may further be made as to size of an unmigrated part of the requested data block; if the unmigrated part is large (for example, exceeds a predefined threshold defined in terms of data volume), then it is considered that a long time is further needed before completing the data migration. Therefore, the migration of the requested data block may be quitted, and the requested data block is provided from source storage system 410. When the requested data block is returned to client 810, the migration of the requested data block may be resumed.

If the unmigrated part is small (for example, is less than or equal to the predefined threshold), then this indicates that the data migration may be completed within a short time, so the access request is delayed and the requested data is provided to the client after completing the data migration.

In one embodiment of the present invention, the source storage system is one of a Storage Area Network and a Network Attached Storage system, and the target storage system is the other of the Storage Area Network and the Network Attached Storage system.

For example, the source storage system may be the Storage Area Network, while the target storage system may be the Network Attached Storage system. In this embodiment, since the virtual file system in the target storage system may directly read data blocks in the Storage Area Network, data may be transmitted on the basis of the Fiber Channel within the Storage Area Network and the data transmission rate is quite high during data migration. In some embodiments, data may further be migrated from the Network Attached Storage System to the Storage Area Network. Those skilled in the art may design migration details on the basis of the above principles.

Note although the Storage Area Network and the Network Attached Storage system are taken as concrete examples of the source storage system and the target storage system in the context of the present invention, those skilled in the art should understand that the technical solution of the present invention may further be applicable to perform data migration between other types of storage systems.

In one embodiment of the present invention, after the data migration is completed, a data storage device in the source storage system may be attached to the target storage system to serve as a data storage device inside the target storage system. In this embodiment, after the data migration is completed, the storage device in the source storage system may serve as one part of storage devices within the target storage system and is subject to unified scheduling of a storage manager of the target storage system. In this manner, the storage capacity within the source storage system can be reused on the one hand, and on the other hand the shortage of storage capacity in the target storage system can be solved.

Various embodiments implementing the method of the present invention have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus based on the same invention concept. Even if the apparatus has the same hardware structure as a general-purpose processing device, the functionality of software contained therein makes the apparatus manifest distinguishing properties from the general-purpose processing device, thereby forming an apparatus of the various embodiments of the present invention. The apparatus described in the present invention comprises several means or modules, the means or modules configured to execute corresponding steps. Upon reading this specification, those skilled in the art may understand how to write a program for implementing actions performed by these means or modules. Since the apparatus is based on the same invention concept as the method, the same or corresponding implementation details are also applicable to means or modules corresponding to the method. As detailed and complete description has been presented above, the apparatus is not detailed below.

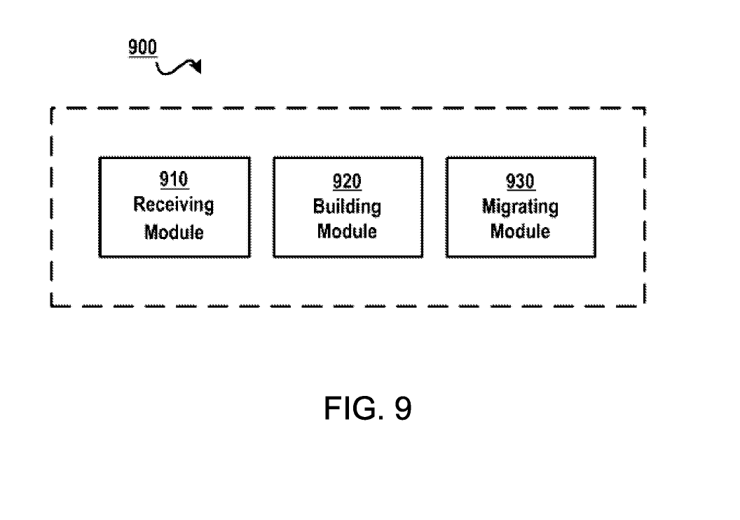

FIG. 9 schematically shows a block diagram 900 of an apparatus for data migration according to one embodiment of the present invention. As shown in FIG. 9, there is provided an apparatus for data migration, comprising: a receiving module 910 configured to receive a migration request for data migration from a source storage system to a target storage system; a building module 920 configured to build a virtual file system for reading data blocks in the source storage system; and a migrating module 930 configured to migrate data blocks in the source storage system to the target storage system via the virtual file system, wherein the source storage system and the target storage system are storage systems of different types.

Building module 920 comprises: an obtaining module configured to obtain a source file system description of the source storage system and a target file system description supported by the target storage system respectively; and a virtual file system building module configured to build the virtual file system on the basis of the source file system description and the target file system description. In some embodiments of the present invention, the virtual file system is implemented in the target storage system.

Migrating module 930 comprises: a setting module configured to, with respect to data blocks in the source storage system, set metadata that describes migration status of the data blocks on the basis of the progress of copying the data blocks from the source storage system to the target storage system, the metadata comprising at least one of “unmigrated,” “under migration” and “migrated.”

Some embodiments of the present invention further include: a guiding module configured to, in response to detecting an access request of a client to the source storage system, guide the access request to the target storage system; and a providing module configured to provide by the target storage system a data block requested by the access request.

In some embodiments of the present invention, the providing module (sometimes herein referred to as a “data providing module” comprises: a determining module configured to determine migration status of the requested data block on the basis of the metadata; and a data providing module configured to provide the requested data block on the basis of the migration status of the requested data block. In some embodiments, the providing module includes one, or more, of the following components: (i) a first providing sub-module configured to, in response to the migration status being “unmigrated,” provide the requested data block from data storage of the source storage system; (ii) a second providing sub-module configured to, in response to the migration status being “migrated,” provide the requested data block from data storage of the target storage system; (iii) a measuring module configured to, in response to the migration status being “under migration,” determine size of an unmigrated part of the requested data block; and/or (iv) a third providing sub-module configured to, in response to the size being larger than a predefined threshold, quit the data migration and providing the requested data block from data storage of the source storage system; otherwise, delay the access request until the data migration is completed, and provide the requested data block from data storage of the target storage system.

In some embodiments, the source storage system is one of a Storage Area Network and a Network Attached Storage system, and the target storage system is the other of the Storage Area Network and the Network Attached Storage system.

In some embodiments, more convenient and efficient data migration can be provided without changing the architecture of an existing data storage system as far as possible. Furthermore, a client desiring to access a data storage system can still access the data storage system during data migration.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for data migration, the method comprising:
receiving a migration request for data migration from a source storage system to a target storage system, with the source storage system and the target storage system being of different types of storage systems;
building a virtual file system for reading data blocks in the source storage system; and
migrating a plurality of data blocks in the source storage system to the target storage system via the virtual file system.

2. The method according to claim 1, wherein the building of the virtual file system for reading data blocks in the source storage system comprises:
obtaining a source file system description of the source storage system and a target file system description supported by the target storage system; and
building the virtual file system on the basis of the source file system description and the target file system description.

3. The method according to claim 1, wherein the virtual file system is implemented in the target storage system.

4. The method of claim 1 further comprising:
in response to detecting an access request of a client to the source storage system, guiding the access request to the target storage system; and
providing, by the target storage system, a data block requested by the access request.

5. The method of claim 4 wherein the migrating of data blocks in the source storage system to the target storage system via the virtual file system comprises:
with respect to data blocks in the source storage system, setting metadata that describes migration status of the data blocks on the basis of progress of copying the data blocks from the source storage system to the target storage system, with the metadata indicating one of the following status states: “unmigrated,” “under migration” or “migrated.”

6. The method according to claim 5, wherein the providing by the target storage system the data block requested by the access request comprises:
determining migration status of the requested data block on the basis of the metadata; and
providing the requested data block on the basis of the migration status of the requested data block.

7. The method according to claim 6, wherein the providing the requested data block on the basis of the migration status of the requested data block comprises:
in response to the migration status being “unmigrated,” providing the requested data block from data storage of the source storage system.

8. The method according to claim 6, wherein the providing the requested data block on the basis of the migration status of the requested data block comprises:
in response to the migration status being “migrated,” providing the requested data block from data storage of the target storage system.

9. The method according to claim 6, wherein the providing the requested data block on the basis of the migration status of the requested data block comprises:
in response to the migration status being “under migration,” determining size of an unmigrated part of the requested data block;
on condition that the size is larger than a predefined threshold, quitting the data migration and providing the requested data block from data storage of the source storage system; and
on condition that the size is not larger than the predefined threshold, delaying the access request until the data migration is completed, and providing the requested data block from data storage of the target storage system.

10. The method according claim 1 wherein:
the source storage system is one of a Storage Area Network and a Network Attached Storage system; and
the target storage system is the other of the Storage Area Network and the Network Attached Storage system.

11. An apparatus for data migration, the apparatus comprising:
a receiving module configured to receive a migration request for data migration from a source storage system to a target storage system, with the source storage system and the target storage system being of different types of storage systems;
a building module configured to build a virtual file system for reading data blocks in the source storage system; and
a migrating module configured to migrate a plurality of data blocks in the source storage system to the target storage system via the virtual file system.

12. The apparatus according to claim 11, wherein the building module comprises:
an obtaining sub-module configured to obtain a source file system description of the source storage system and a target file system description supported by the target storage system respectively; and
a virtual file system building sub-module configured to build the virtual file system on the basis of the source file system description and the target file system description.

13. The apparatus according to claim 11, wherein the virtual file system is implemented in the target storage system.

14. The apparatus according claim 11 further comprising:
a guiding module configured to, in response to detecting an access request of a client to the source storage system, guide the access request to the target storage system; and
a providing module configured to provide by the target storage system a data block requested by the access request.

15. The apparatus according to claim 14, wherein the migrating module comprises:
a setting sub-module configured to, with respect to data blocks in the source storage system, set metadata that describes migration status of the data blocks on the basis of progress of copying the data blocks from the source storage system to the target storage system, the metadata indicating one of the following status states: “unmigrated,” “under migration” or “migrated.”

16. The apparatus according to claim 15, wherein the providing module comprises:
a determining sub-module configured to determine migration status of the requested data block on the basis of the metadata; and
a data providing sub-module configured to provide the requested data block on the basis of the migration status of the requested data block.

17. The apparatus according to claim 16, wherein the data providing sub-module comprises:
a first providing sub-sub-module configured to, in response to the migration status being “unmigrated,” provide the requested data block from data storage of the source storage system.

18. The apparatus according to claim 16, wherein the data providing sub-module comprises:
a second providing sub-sub-module configured to, in response to the migration status being “migrated,” provide the requested data block from data storage of the target storage system.

19. The apparatus according to claim 16, wherein the data providing sub-sub-module comprises:
a measuring sub-sub-module configured to, in response to the migration status being “under migration,” determine size of an unmigrated part of the requested data block; and
a third providing module configured to:
on condition that the size is larger than a predefined threshold, quit the data migration and provide the requested data block from data storage of the source storage system, and
on condition that the size is smaller than the predefined threshold, delay the access request until the data migration is completed, and provide the requested data block from data storage of the target storage system.

20. The apparatus according to claim 11 wherein:
the source storage system is one of a Storage Area Network and a Network Attached Storage system; and
the target storage system is the other of the Storage Area Network and the Network Attached Storage system.
